(19) United States
(12) Patent Application Publication
(10) Pub. No.: US 2013/0238905 A1
(43) Pub. Date: Sep. 12, 2013

(54) DATA SHIELDING SYSTEM AND METHOD

(71) Applicant: Francis Dinha, Dublin, CA (US)

(72) Inventor: Francis Dinha, Dublin, CA (US)

(21) Appl. No.: 13/417,227

(22) Filed: Mar. 10, 2012

(51) Int. Cl. G06F 21/24

(52) U.S. Cl. 713/189

(57) ABSTRACT

A processor-based system and method comprising a display engine that creates a virtual space on a user device. An interface engine is operable to sense an interaction with a user, and in response to that interaction, receive a key from a remote server and apply a cipher. The interaction may be a user dragging or dropping a file or other data into the virtual space. The interface may then detect the file, query a remote server to retrieve a key and apply the cipher to the data using the key. The ciphers may be dynamically changed for different files. Display indicia show encrypted and non-encrypted files in a format that indicates their state. In certain embodiments the system may act as a server delivering secure and non-secure information to other processes.

### BACKGROUND

Data security in computing systems has always been one of the more difficult challenges both for users and for service providers. At each step of processing computer data, from creations, storage, and transmission, there is a risk of a security compromise. The results of a compromise could be tragic. Even advanced data encryptions schemes are subject to theft because of the requirement for a password or private identification number (PIN). Studies indicate that often the password or PIN is written on a sticky note attached to the computer. This allows for easy theft of the data. The reason users place passwords near their computer is because passwords are difficult to remember. The problem of remembering passwords is exacerbated when high-level encryption is employed because encryption may use large numbers as keys and those numbers are hard to remember.

The Computer Security Institute reported that in 2007, 71% of companies surveyed utilized encryption for some of their data in transit, and 53% utilized encryption for at least some of their data in storage. Encryption can be used to protect data such as files on computers and storage devices. There have been numerous reports of confidential data being exposed through loss or theft of laptops or backup drives. Encrypting such files helps protect them when physical security measures fail.

Encryption is also used to protect data in transit, for example and without limitation, data being transferred via networks (e.g. the Internet, e-commerce), mobile telephones, wireless microphones, wireless intercom systems, Bluetooth devices and bank automatic teller machines. However, data in transit may be intercepted. Encrypting data in transit helps to secure it because it is difficult to physically secure all networks.

Encryption, by itself, can protect the confidentiality of messages, but other techniques are still needed to protect the integrity and authenticity of a message; for example and without limitation, verification of a message authentication code (MAC) or a digital signature. Successfully using encryption to ensure security is a challenging problem. A single error in system design or execution can allow successful security breaches.

### SUMMARY

Disclosed herein is a processor-based system and method which includes a display engine that creates a virtual space (“locker”) on a user device. An interface engine is operable to sense an interaction with a user. And in response to that interaction, receive a key from a remote server and apply a cipher. The interaction may be a user dragging or dropping a file or other data into the virtual locker. The virtual locker may be formed to look like a safe, lockbox or other representation indicating security. In addition, files within the security virtual area may have indicia indicating their encrypted state.

The interface may then detect a file when it is dragged or otherwise copied into the secure area. A query to a remote server may then retrieve a key and apply a previously installed cipher to the file/folder using the key. Display indicia then shows encrypted (locked) and non-encrypted (unlocked) files in a format that indicates their state. Thus the result may be an encrypted file with a different icon. The reverse process may occur when a file/folder is dragged out of or removed from the security virtual area. The file would be decrypted and its icon changed to represent that decryption.

The ciphers may be dynamically changed for different files (or file types) allowing for more or less enhanced file security. In certain embodiments the encryption may be dynamic allowing for streaming secure information to remote sites. Moreover, in certain embodiments the system may act as a server delivering secure and non-secure information to other processes.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 shows a functional block diagram of a client server system that may be employed for some embodiments according to the current disclosure.

FIG. 2 illustrates certain embodiments according to the current disclosure.

FIG. 3 shows a flowchart of a method according to the current disclosure.

FIG. 4 shows a functional block diagram including certain graphical and functional elements according to the current disclosure.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Read this application with the following terms and phrases in their most general form. The general meaning of each of these terms or phrases is illustrative, not in any way limiting.

### Lexicography

The term “application programming interface” or “API” generally refers to a code-based specification intended to be used as an interface by software components to communicate with each other. An API may include specifications for routines, data structures, object classes, and variables.

The terms “cipher” or “cipher” generally refers to an algorithm for performing encryption or decryption.

The term “declarative language” generally refers to a programming language that allows programming by defining the boundary conditions and constraints and letting the computer determine a solution that meets these requirements. Many languages applying this style attempt to minimize or eliminate side effects by describing what the program should accomplish, rather than describing how to go about accomplishing it. This is in contrast with imperative programming, which requires an explicitly provided algorithm.

The term “HTML Injection” generally refers to injecting HTML code into a web server's response to alter the content to the end user. This is also known as cross site scripting.

The term “extension” and “browser extension” and the like generally refer to a computer program, applet or instructions that extend the functionality of a web browser in some way. Depending on the browser, the term may be distinct from similar terms such as plug-in or add-on.

The term “encryption” generally refers to the process of transforming information (referred to as plaintext) using an algorithm (called a cipher) to make it unreadable to anyone except those possessing special knowledge, usually referred to as a key. The result of the process is encrypted information (or ciphertext). The reverse process, making the encrypted information readable again, is generally referred to as decryption. The word encryption may also refer to the reverse process as well. For example, “software for encryption” often performs decryption.

The word “Middleware” generally means computer software that connects software components or applications. The software consists of a set of enabling services that allow multiple processes running on one or more machines to interact across a network. Middleware conventionally provides for interoperability in support of complex, distributed applications. It often includes web servers, application servers, and similar tools that support application development and delivery such as XML, SOAP, and service-oriented architecture.

The term “service level agreement” (SLA) generally means an agreement between providers for Internet based computing resources such as servers, databases, and data storage systems and clients. SLAs generally contain details about what services are available, pricing for those services and availability for those resources. SLAs may also include workload, queue size, disk space availability, CPU load, network latency, or business metrics such as cost or location.

The terms “software as a service” or “SaaS” or “on-demand software” generally mean a software delivery model in which software and its associated data are hosted centrally such as on the Internet or cloud and accessed by users using a client. SaaS is a common delivery model for many business applications, including accounting, collaboration, customer relationship management (CRM), management information systems (MIS), enterprise resource planning (ERP), invoicing, human resource management (HRM), content management (CM) and service desk management.

The term “structured data” generally refers to data stored in a meaningful fashion such that a processor may be instructed to access the data. Examples include but are not limited to databases, relational databases, text files, XML file and the like.

The term “wireless device” generally refers to an electronic device having communication capability using radio, optics and the like.

The term “virtual machine” or “VM” generally refers to a self-contained operating environment that behaves as if it is a separate computer even though it is part of a separate computer or may be virtualized using resources form multiple computers.

The acronym “XML” generally refers to the Extensible Markup Language. It is a general-purpose specification for creating custom markup languages. It is classified as an extensible language because it allows its users to define their own elements. Its primary purpose is to help information systems share structured data, particularly via the Internet, and it is used both to encode documents and to serialize data.

### System Elements

### Processing System

The methods and techniques described herein may be performed on a processor based device. The processor based device will generally comprise a processor attached to one or more memory devices or other tools for persisting data. These memory devices will be operable to provide machine-readable instructions to the processors and to store data, including data acquired from remote servers. The processor will also be coupled to various input/output (I/O) devices for receiving input from a user or another system and for providing an output to a user or another system. These I/O devices include human interaction devices such as keyboards, touch screens, displays and terminals as well as remote connected computer systems, modems, radio transmitters and handheld personal communication devices such as cellular phones, “smart phones” and digital assistants.

Certain embodiments may include mass storage devices such as disk drives and flash memory modules as well as connections through I/O devices to servers containing additional storage devices and peripherals. Certain embodiments may employ multiple servers and data storage devices thus allowing for operation in a cloud or for operations drawing from multiple data sources. The inventor contemplates that the methods disclosed herein will operate over a network such as the Internet, and may be effectuated using combinations of several processing devices, memories and I/O.

The processing system may be a wireless devices such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality.

### Client Server Processing

Client-server processing includes, but is not limited to operations between multiple processor-based devices wherein the processing is partially performed on different computing devices. Conventionally a server is coupled to one or more databases and to a network. A user accesses the server by a computer communicably coupled to the network. Alternatively the user may access the server through the network by using a smart device such as a telephone or PDA. The smart device may connect to the server through an access point coupled to the network.

Conventionally, client server processing operates by dividing the processing between two devices such as a server and a smart device such as a cell phone or other computing device. The workload is divided between the servers and the clients according to a predetermined specification. For example in a “light client” application, the server does most of the data processing and the client does a minimal amount of processing, often merely displaying the result of processing performed on a server.

According to the current disclosure, client-server applications are structured so that the server provides machine-readable instructions to the client device and the client device executes those instructions. The interaction between the server and client indicates which instructions are transmitted and executed. In addition, the client may, at times, provide for machine readable instructions to the server, which in turn executes them. Several forms of machine readable instructions are conventionally known including applets and are written in a variety of languages including Java and JavaScript.

Client-server applications also provide for software as a service (SaaS) applications where the server provides software to the client on an as needed basis.

In addition to the transmission of instructions, client-server applications also include transmission of data between the client and server. Often this entails data stored on the client to be transmitted to the server for processing. The resulting data is then transmitted back to the client for display or further processing.

One having skill in the art will recognize that client devices may be communicably coupled to a variety of other devices and systems such that the client receives data directly and operates on that data before transmitting it to other devices or servers. Thus data to the client device may come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein certain embodiments may include a display engine, a data engine, an interface engine, a user interface and the like. for example and without limitations, engines may do one of more of the following:
Seek and gather information, including information about events, from remote data sources
Display, or cause to be displayed, information to a user
Perform calculations
Store data locally and/or remotely.

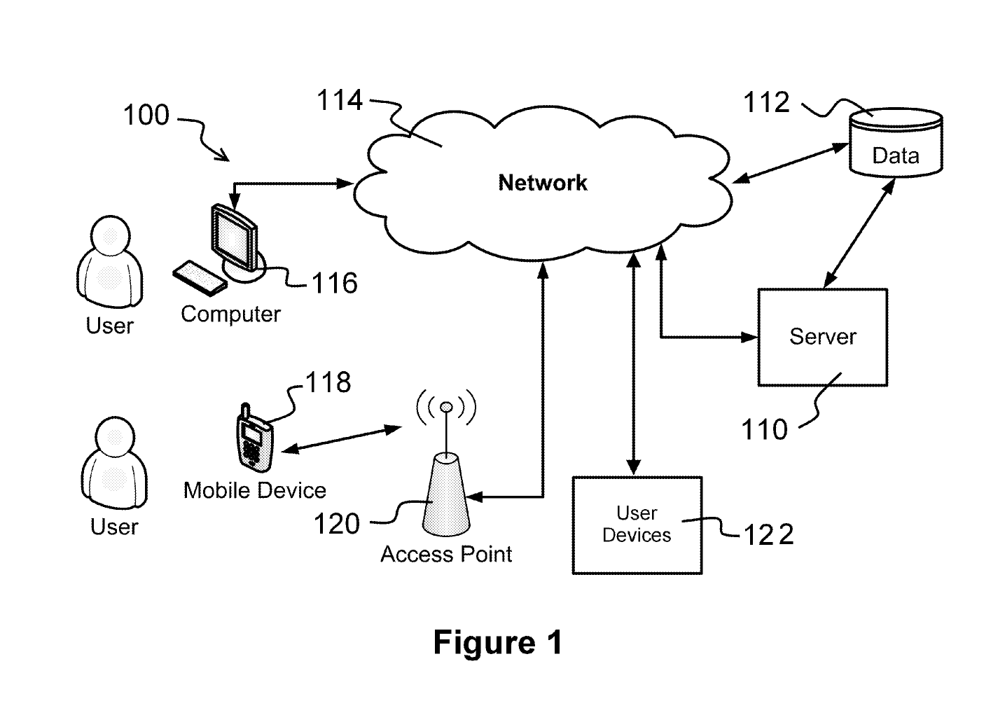

FIG. 1 shows a functional block diagram of a client server system 100 that may be employed for some embodiments according to the current disclosure. In the FIG. 1 a server 110 is coupled to one or more databases 112 and to a network 114. The network may include routers, hubs and other equipment to effectuate communications between all associated devices. A user accesses the server by a computer 116 communicably coupled to the network 114. The computer 116 includes a sound capture device such as a microphone (not shown). Alternatively the user may access the server 110 through the network 114 by using a smart device such as a telephone or PDA 118. The smart device 118 may connect to the server 110 through an access point 120 coupled to the network 114. The mobile device 118 includes a sound capture device such as a microphone.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

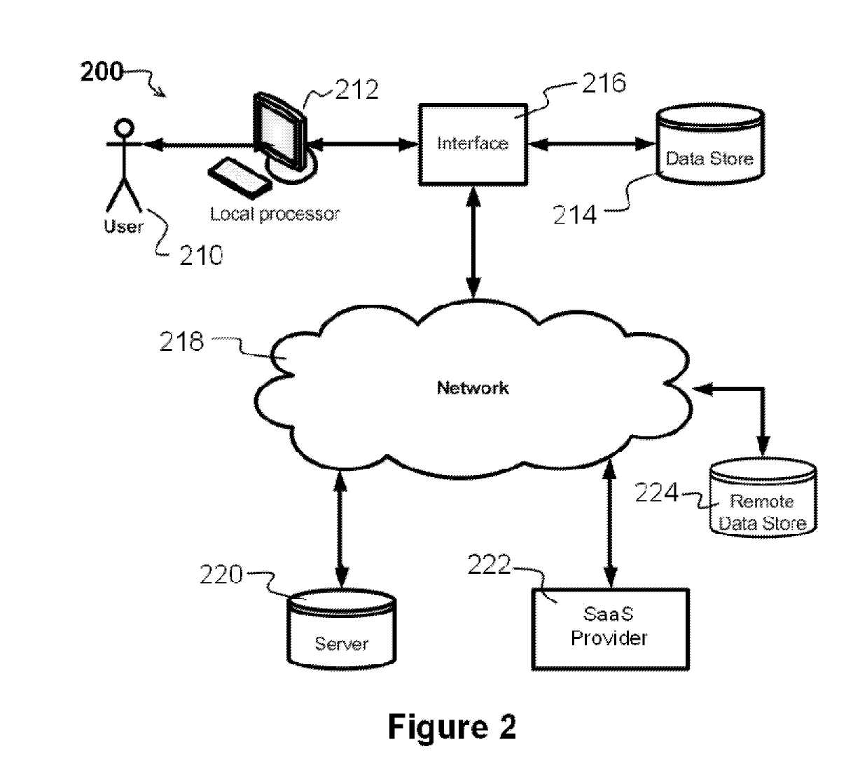

FIG. 2 illustrates certain embodiments according to the current disclosure. In FIG. 2 a user 210 operates a local processing device 212. As noted herein, the local processor may be a personal computer, mobile phone, tablet, laptop and the like. The processing device 212 is coupled to an interface 216. The interface 216 may be an software engine comprised of processor-readable instructions for interacting with the user 210 and other associated processing software and devices. The Interface may reside on the local processor 212 or be provided from a remote server. The interface 216 is coupled to a network 218 such as the Internet or local area network. And the interface 216 is coupled to a structured data store 214. The structured data store may be any device operable to store programming instructions and/or data including, but not limited to random access memory (RAM), a hard drive, static or dynamic RAM, CR ROMs and the like.

The network 212 is coupled to a server 220. The server 220 may operate to provide program instructions and data to other network connected systems. The network 218 may also be coupled to a remote data store 224, similar in functionality to the data store 214. A software-as-a-service (SaaS) provider 222 may be coupled to the network 218 and is operable to provide software services to users coupled to the SaaS provider 222. These software services include, but are not limited to, user interfaces, software and script access, HTML injection, data access and the like. Commercially available SaaS providers include online banking, tax returns, document editing, spreadsheets, image editing tools and other SaaS providers are entering the marketplace.

The interface 216 is operable to communicate with a server 220 and the processor 212 for providing at least one of the following services:
Downloading program files for execution on the local processor 212
Accessing data stored on the server 220 and supplying it to the local processor 212.
Performing HTML and JavaScript injection for information to the user 210.
Providing a user interface to the user 210 via the local processor 212.
Requesting and receiving a key from a server 220.
Applying a cipher to files received from a local processor 212, or a server 220, or a data store 214, or a remote data store 224.
Move files between various storage facilities.
Interact with a SaaS Provider 222 and the local processor 212 to alter the functionality of the SaaS.

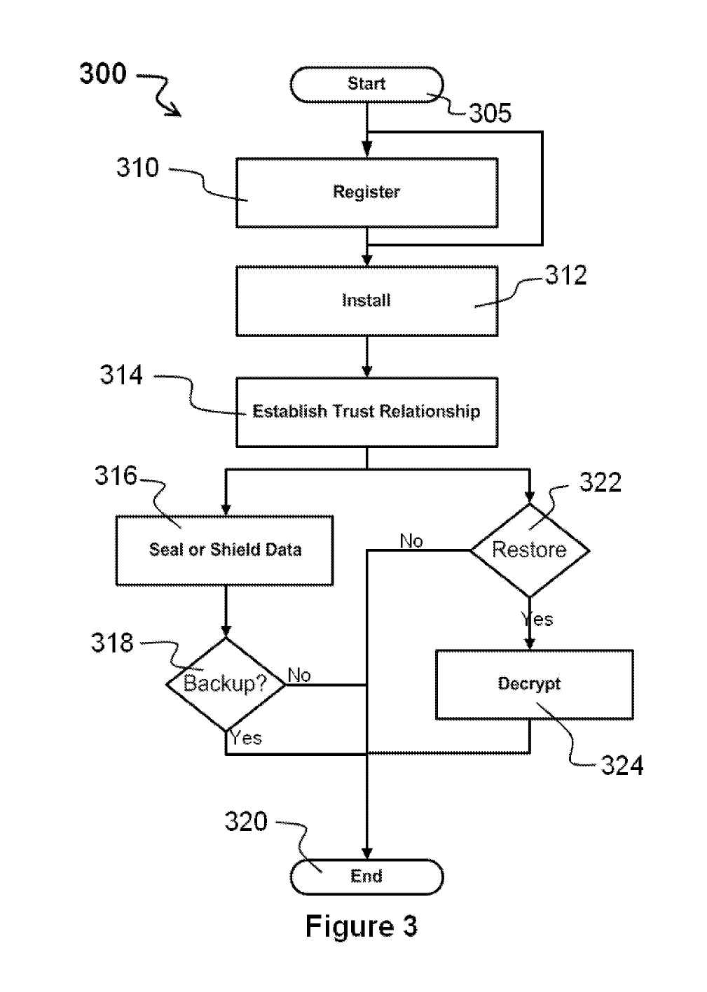

FIG. 3 shows a flowchart of a method according to the current disclosure. In FIG. 3 a method begins at a flow label 305. At a step 310 is a registration process. The registration 310 includes a user signup and authentication procedure. At the step 310 user information is collected and in certain embodiments, the user information may be verified by a closed loop process. For example and without limitation, the closed loop process may include sending a verification email or telephone call to a new user to confirm an email address or phone number. Other verification steps may include mailing a letter or postcard to verify a mailing address. The registration step also includes storing the registration information (user name, email address, etc.) in a structured data source. Once a registration step is performed it may be optional in later operations of the method 300.

At a step 312 all or a portion of a user interface engine may be installed on a processor-based device. The installation step may include downloading software to facilitate future login operations to a remote server, downloading encryption software, and downloading software to implement all or portions of a user interface engine. The inventor contemplates multiple variations of the install step 312 based on the type of processor, operating system and peripherals available for use as an interface engine. The install step 312 may provide for querying a user about information related to certain embodiments. For example and without limitation, these queries may include user name, email address, and type of trust relationship (single-factor authentication, dual-factor authentication, tokens, call-back, fixed IP address and the like).

### Establish Trust Relationship

At a step 314 a trust relationship is established. This trust relationship may include anti-virus protection, two-factor authentication or hardware security. Trust relationships include security that governs connections over a protected communications channel to a network such as the Internet or a cloud network and through to devices coupled to those networks. Trust relationships may include a quarantine process to ensure that the client computer has the latest security updates, anti-virus definitions, personal firewall enabled and so on before being allowed to access the service endpoints. Certain embodiments may include the following factors for security:
Device ownership factors such as a physical phone, or cell phone or other controlled device to verify identity.
Knowledge factors such as a password, pass phrase, or personal identification number (PIN), challenge response (the user must answer a question) and the like.
Inherence factors such as a fingerprint, retinal pattern, voice, or other biometric identifiers that verify identity.

Multiple-factor security including but not limited to combinations of the above factors will provide for a more robust trust relationship. Once a trust relationship is established the method moves to either a step 316 or a step 322 under direction of a user.

### Encryption

At a step 316 data is sealed (or shielded/locked). The data may be any form of electronic information including but not limited to text or document files, spreadsheets, compressed data files and the like. The process of sealing/locking the data may be accomplished by first having software instructions to present indicia such as an icon on a user interface. This may be effectuated using an icon on a desktop. In certain embodiments the icon may represent a safe, lockbox or other secure setting. The indicia may represent a virtual space (or virtual locker) on the interface and show icons representing items in that virtual space. Second, having a user drag the data into or on top of the icon or virtual locker. This would signal an event that would begin the sealing process. Encrypted data files may be represented by additional indicia within or associated with the first indicia. Moreover, the indicia may change indicating the status of the sealing process, thus allowing a user to monitor the process, or simply drop the file into the “safe” icon and return to other tasks without having to wait until the encryption is complete. Encrypted items may be represented by icons in the virtual locker.

The virtual space is not limited to any real physical space but may include screen real estate, wherein the files in the virtual space are designated or marked as belonging to that space with any requirement that those files are relocated to a different location. Moreover, the virtual space may be one or more predetermined disk or storage locations including remote locations.

The sealing/locking process may include sending a request to a server, including a remote server, requesting an encryption key. The encryption key may be then used to encrypt the data. Encryption is typically applied at the creation time of the document and on the same device it has been composed on to avoid tampering. Otherwise any node between the sender and the encryption agent could potentially tamper it. Accordingly in certain embodiments encryption may be done by a local processor before any sensitive information is exposed to a local network or the Internet. However, one having skill in the art would recognize that multiple encryption and secure communications channels may provide for secure encryption at a remote location. For example and without limitation, the HTTPS protocol signals a web browser to use an added encryption layer of SSL/TLS to protect traffic, thus allowing for reasonably secure communications.

Commercial encryption tools such as APIs and web services often employ the advanced encryption standard (AES) specification for encryption of electronic data. Alternatively any number of encryption tools such as DES may also be employed. The algorithm described by AES is a symmetric-key algorithm, meaning the same key is used for both encrypting and decrypting the data, while other encryption schemes may use non-symmetric keys.

AES is based on a design principle known as a substitution-permutation network. It is fast in both software and hardware. AES has a fixed block size of 128 bits and a key size of 128, 192, or 256 bits. The blocksize has a maximum of 256 bits, but the keysize has no theoretical maximum. AES operates on a 4×4 column-major order matrix of bytes, termed the state. Most AES calculations are done in a special finite field. The AES cipher is specified as a number of repetitions of transformation rounds that convert the input plaintext into the final output of ciphertext. Each round consists of several processing steps, including at least one that depends on the encryption key. A set of reverse rounds may also be applied to transform ciphertext back into the original plaintext using the same encryption key.

In addition to AES encryption several other techniques are known for file encryption. For example, filesystem-level encryption (file or folder encryption), is a form of disk encryption where individual files are encrypted by the file system. The operating system then determines the encryption technique.

Once the data is sealed/locked the method advances to a step 318. At step 318 the encrypted file may be backed up or otherwise saved in a secure location. That location may be a remote server or through a SaaS provider such as Dropbox.com or other online file backup service. The backup step 318 may be effectuated automatically depending on certain parameters or done manually by a user.

For data being decrypted the method moves from a step 314 to a step 322. At the step 322 restoration is effectuated. Restoration may be from a local or remote server, or from a SaaS provider such as Dropbox.com or other online file backup service. The restore step 318 may be effectuated automatically depending on certain parameters or done manually by a user.

At a step 324 decryption is effectuated. Decryption uses a reverse process than the encryption steps described above. The process of decryption (unsealing or un-shielding) may be accomplished by first having software instructions to present indicia to a user. The indicia may be an icon on a user interface representing a file or folder or the secure setting described above wherein an icon of a safe or lockbox represents a storage area for encrypted data. Within or superimposed over the indicia may be additional indicia representing encrypted data files. Dragging the file or folder icon from the encrypted area (icon) to a desktop would instigate a decryption process.

The unsealing process may include sending a request to a server, including a remote server, requesting a key. The key may then be used to decrypt the data. Decryption is typically applied at the user site of the document and on the same device it has been composed on to avoid tampering.

At a flow market 320 the method ends.

In certain embodiments portions of the method 300 may be controlled by an interface engine as described herein. The interface engine may present (or cause to be presented) the appropriate security indicia such as a safe or lockbox. When a user drags a file into or out of the security indicia, encryption of decryption occurs without further intervention. One having skill in the art will recognize that the step of dragging may be effectuated using other techniques such as cut and paste or other operating system file operation commands.

One benefit of the method 300 is the remote storage and operation of keys and ciphers. The key is not stored locally and there is no requirement that the user have knowledge of the key or cipher. In certain embodiments different ciphers may be used on the same device. Thus the encryption and decryption would appear to be virtually transparent to a user unless changes in indicia are effectuated in response to the ciphering.

The interface engine may use conventional programming techniques to effectuate certain operations. For example and without limitation, SQL Server or MySQL may be used to access a remote server containing keys or trust relationship information. Operating system commands may be used to effect file movement from a first location to a second location. for example and without limitation, event-driven programming techniques would detect a drag and drop event and initiate code to operate on a file. Moreover, file system commands may be used to effectuate removing electronic traces of unsecured data, ciphers and keys after the encryption process is performed.

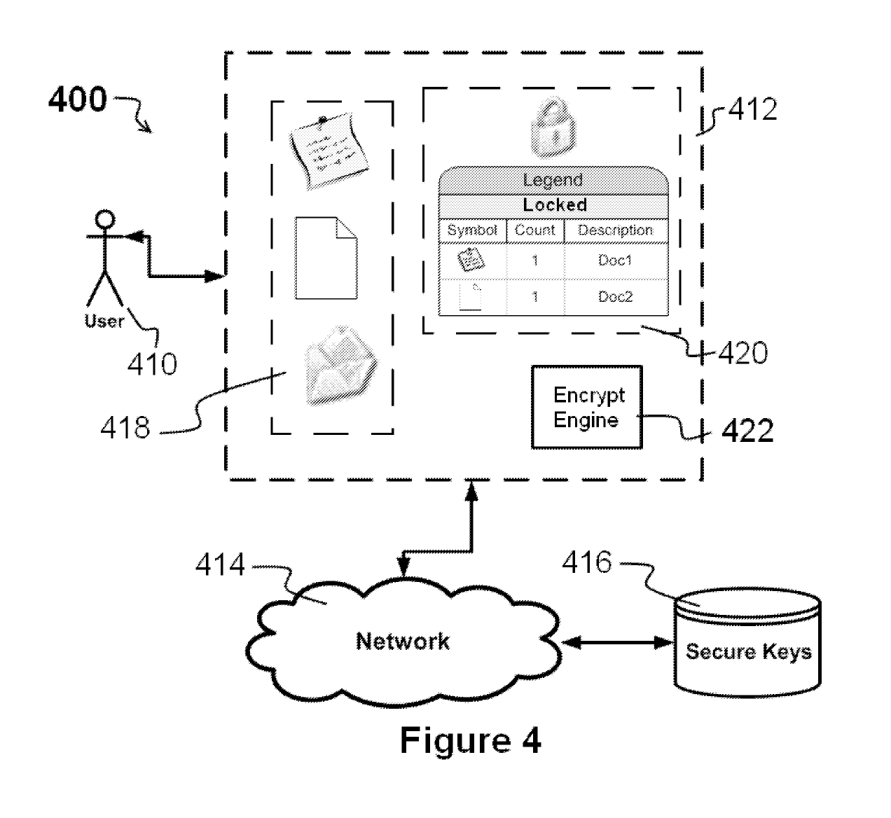

FIG. 4 shows a functional block diagram including certain graphical and functional elements according to the current disclosure. In FIG. 4 a user 410 interacts with a graphical interface 412. The interface provides visualization for unsecured (unencrypted or unlocked) data files 418 and for locked data files 420 in a virtual space (locker). The user 410 drags or otherwise manipulates the interface to move files from the unsecured 418 to the secured area 420 and vice versa. The user's act of moving data file may automatically instantiates the encryption/decryption 422 process.

The encryption/decryption process may involve accessing a secure keys server 416 through a network 414. The secure keys server 416 would respond to a request for keys from a properly authenticated user or device having the requisite trust relationship.

Besides security, the locked data files 420 may include file operations such as copy, paste and delete, and also allow for location information. The location information may be a local drive, a remote server or a location where a SaaS application can retrieve the data such as a cloud server or other similarly networked storage device.

The interface 412 may also act as a server wherein a properly authenticated local or remote service requests access to the locked data file 420. If properly authenticated, the interface 412 serves the files to the requesting device or application. This has the effect of providing locally secured data to remote programs thus inhibiting a 3^{rd} party or SaaS provider security breach. Dynamic (or on-the-fly) encryption may be employed to effectuate an interface acting as a server. Conventional dynamic encryption techniques such as the SSL protocol and the wired equivalent privacy (WEP) security algorithm for IEEE 802.11 wireless networks may be employed. WEP uses the stream cipher RC4 for confidentiality, and the CRC-32 checksum for integrity. Commercial dynamic encryption tools are also available such as FreeOTFE and BitLocker which provide on-the-fly encryption for disk access.

Server operation may be effected by using the interface 412 on a local processing device and adding a wrapper. The wrapper acts as an intermediary for the conventional application by exposing a web service interface to the client. In addition to the processes disclosed herein, the wrapper may perform one or more of the following:
Listen for calls from remote devices.
Receive or transmit files or data.
Encrypt or decrypt data.
Supply ciphers or keys.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

1. A system comprising:
a processor;
a memory, coupled to said processor;
a display engine, said display engine operable to display at least one indicium representing a virtual space;
an interface engine coupled to said processor and to the display engine, said interface engine operable to sense an interaction between a file and a user, and in response to said interaction, request an electronic encryption key from a remote server, receive a key from the remote server, apply a cipher to the file using the electronic key and remove any electronic trace of the key.

2. The system of claim 1 wherein the interface engine alters the indicium to indicate encryption of one or more data files in the virtual space.

3. The system of claim 1 wherein the cipher is decryption or encryption.

4. The system of claim 1 wherein said interaction is a user placing one or more data files or text files in the virtual space.

5. The system of claim 1 wherein the interface engine is operable to establish a trust relationship with the user.

6. The system of claim 1 wherein the trust relationship is a two-factor authentication.

7. The system of claim 1 wherein system is a mobile computing device.

8. A method including:
presenting at least one indicium on a display;
receiving an indication of an interaction with the indicium, said interaction including at least a file;
presenting credentials to a remote server in response to said interaction;
receiving an electronic key in response to said presenting;
applying a cipher to the file using the electronic key, and
remove any electronic trace of the key.

9. The method of claim 8 further including altering the indicium to indicate encryption.

10. The method of claim 8 wherein the cipher is decryption or encryption.

11. The method of claim 8 wherein the file is a text file or data file.

12. The method of claim 8 further including establishing a trust relationship.

13. The method of claim 12 wherein the trust relationship is a multiple-factor authentication.

14. The method of claim 8 wherein the display is on a mobile computing device.

15. One or more processor readable storage devices having processor readable non-transitory code embodied on said processor readable storage devices, said code for programming one or more processors to perform a method comprising:
presenting at least one indicium on a display;
receiving an indication of an interaction with the indicium, said interaction including at least a file;
presenting credentials to a remote server;
receiving an electronic key in response to said presenting, and
applying a cipher to the file using the key, and
removing any electronic trace of the key.

16. The storage device of claim 15 wherein the method further includes altering the indicium to indicate encryption.

17. The storage device of claim 15 wherein the cipher is decryption or encryption.

18. The storage device of claim 15 the method further includes establishing a trust relationship.

19. The storage device of claim 18 wherein the trust relationship is a multiple-factor authentication.

20. The storage device of claim 15 wherein the display is on a mobile computing device.
